(19) United States
(12) Patent Application Publication
(10) Pub. No.: US 2026/0160184 A1
(43) Pub. Date: Jun. 11, 2026

(54) TURBINE HAVING GUIDE BAFFLE AND GAS TURBINE INCLUDING SAME

(71) Applicant: DOOSAN ENERBILITY CO., LTD., Changwon (KR)

(72) Inventors: Joo Heon JEON, Changwon (KR); Seung Yeob LEE, Seoul (KR); Do Won HAN, Busan (KR)

(21) Appl. No.: 19/390,689

(22) Filed: Nov. 17, 2025

(30) Foreign Application Priority Data
Dec. 10, 2024 (KR) 10-2024-0182611

(51) Int. Cl. F01D 25/14

(52) U.S. Cl. CPC F01D 25/14; F05D 2240/126; F05D 2240/14; F05D 2250/191; F05D 2260/201; F05D 2260/31

(57) ABSTRACT

A turbine having a guide baffle and a gas turbine including the turbine are provided. The turbine includes a turbine vane carrier having an inner circumferential surface to which a plurality of turbine vanes are coupled, a turbine casing having an inner portion on which the turbine vane carrier is mounted, the turbine casing being provided with a cooling air inlet configured to supply cooling air towards the turbine vane carrier, and a guide baffle mounted on an outer circumferential portion of the turbine vane carrier and configured to guide the cooling air supplied through the cooling air inlet to an outer circumferential surface of the turbine vane carrier.

### CROSS REFERENCE TO RELATED APPLICATION

This application claims priority to Korean Patent Application No. 10-2024-0182611, filed December 10, 2024, the disclosure of which is incorporated herein by reference in its entirety.

### BACKGROUND

### Technical Field

Apparatuses and methods consistent with exemplary embodiments relate to a turbine and a gas turbine including the turbine, and more particularly, to a turbine and a gas turbine including the turbine that is provided with a guide baffle mounted on the turbine vane carrier to improve a surface heat transfer of the turbine vane carrier.

### Description of the Related Art

A turbine is a mechanical apparatus that acquires a rotational force by an impulsive force or reaction force using a flow of a compressible fluid such as steam or gas. The turbine includes a steam turbine using a steam and a gas turbine using a high temperature combustion gas.

The gas turbine includes a compressor, a combustor, and a turbine. The compressor includes an air inlet for introducing air, and a plurality of compressor vanes and compressor blades which are alternately arranged in a compressor housing.

The combustor supplies fuel to the air compressed in the compressor and ignites a mixture of fuel-air with a burner to generate a high temperature and high pressure combustion gas.

The turbine has a plurality of turbine vanes and a plurality of turbine blades disposed alternately in a turbine casing. In addition, a rotor is arranged to penetrate central portions of the compressor, the combustor, the turbine, and an exhaust chamber.

The rotor is rotatably supported at both ends thereof by bearings. In addition, a plurality of disks are fixed to the rotor to connect each blade. A drive shaft of a generator is connected to an end portion of the exhaust chamber.

A gas turbine has no reciprocating mechanism such as a piston which is usually provided in a four-stroke engine. That is, the gas turbine has no mutual frictional part, such as a piston-cylinder, thereby consuming extremely small lubricant, significantly reducing an amplitude of vibration, unlike the reciprocating machine. Therefore, high speed operation of the gas turbine is possible.

Briefly describing the operation of the gas turbine, the air compressed in the compressor is mixed with fuel, the air-fuel mixture is combusted to produce a high temperature combustion gas, and the combustion gas is injected toward the turbine. The injected combustion gas passes through the turbine vanes and the turbine blades to generate a rotational force, so that the rotor is rotated.

In the gas turbine, cooling may be performed by adding compressed air from the compressor to cool the turbine.

At this time, cooling air flows through a chamber between the turbine casing and a Turbine Vane Carrier (TVC) that supports the turbine vanes, and the cooling air flows toward the turbine vanes and a ring segment.

In a conventional technology, a turbine cooling air pipe that supplies a turbine cooling air is positioned at an upper portion and a lower portion of the turbine casing, which causes an uneven flow between a portion positioned close to the pipe and a portion positioned relatively far from the pipe, resulting in uneven thermal expansion of the turbine vane carrier.

Such uneven thermal expansion may act as a factor that increases the risk of wear during gas turbine operation.

### SUMMARY

Aspects of one or more exemplary embodiments provide a turbine and a gas turbine including the turbine, which may improve a surface heat transfer of a turbine vane carrier, reduce uneven thermal expansion of the turbine vane carrier during operation of the gas turbine, and increase aerodynamic performance.

Additional aspects will be set forth in part in the description which follows and, in part, will become apparent from the description, or may be learned by practice of the exemplary embodiments.

According to an aspect of an exemplary embodiment, there is provided a turbine including: a turbine vane carrier having an inner circumferential surface to which a plurality of turbine vanes are coupled, a turbine casing having an inner portion on which the turbine vane carrier is mounted, the turbine casing being provided with a cooling air inlet configured to supply cooling air towards the turbine vane carrier, and a guide baffle mounted on an outer circumferential portion of the turbine vane carrier and configured to guide the cooling air supplied through the cooling air inlet to an outer circumferential surface of the turbine vane carrier.

The guide baffle may include a perforated plate having a plurality of holes through which the cooling air passes.

The perforated plate may be configured such that the number of holes increases as a distance from the cooling air inlet increases.

The perforated plate may be configured such that the holes are arranged in a larger size as a distance from the cooling air inlet increases.

The guide baffle may include a guide plate positioned radially inside the cooling air inlet and configured to guide the cooling air toward a perforated plate, and the perforated plate positioned relatively far from the cooling air inlet and having a plurality of holes through which the cooling air passes.

The turbine vane carrier may be manufactured separately into an upper half portion and a lower half portion, the upper half portion and the lower half portion may be coupled to each other by a pair of radial flange portions provided on the upper half portion and a pair of radial flange portions provided on the lower half portion, and the turbine vane carrier may be mounted on an inner circumferential portion of the turbine casing by the pair of radial flange portions.

The turbine vane carrier may further include a protruding portion on an upper surface of the upper half portion and a lower surface of the lower half portion, the protruding portions being configured to reduce uneven thermal expansion.

The guide baffle may be configured to cover outer surfaces of the protruding portion, and a part of the guide baffle located adjacent to the cooling air inlet in a circumferential direction among both sides of the protruding portion may have an inclined surface to smoothly guide the cooling air, and an opposite part in close contact with a side surface of the protruding portion may be formed in a stepped shape.

The turbine vane carrier may further include a pair of axial flange portions extending outwardly on both axial sides of the outer circumferential surface of the turbine vane carrier, and the guide baffle may be fastened to the pair of axial flange portions by a plurality of fastening members.

The pair of axial flange portions may be formed such that a radial length of a second axial flange portion of the pair of axial flange portions is greater than a radial length of a first axial flange portion of the pair of axial flange portions, a first side edge portion of the guide baffle may be fastened to an outer circumferential surface of the first axial flange portion by a plurality of fastening members, and a second side edge portion of the guide baffle may be fastened to a coupling member by the plurality of fastening members, the coupling member being coupled to an inner side surface of the second axial flange portion.

According to an aspect of another exemplary embodiment, there is provided a gas turbine including: a compressor configured to compress external air, a combustor configured to mix fuel with air compressed in the compressor to combust a mixture thereof, a turbine having a turbine casing in which a plurality of turbine blades and a plurality of turbine vanes are mounted, the plurality of turbine blades being rotated by a combustion gas discharged from the combustor, a turbine vane carrier having an inner circumferential surface to which the plurality of turbine vanes are coupled, the turbine casing having an inner portion on which the turbine vane carrier is mounted, the turbine casing being provided with a cooling air inlet configured to supply cooling air towards the turbine vane carrier, and a guide baffle mounted on an outer circumferential portion of the turbine vane carrier and configured to guide the cooling air supplied through the cooling air inlet to an outer circumferential surface of the turbine vane carrier.

The guide baffle may include a perforated plate having a plurality of holes through which the cooling air passes.

The perforated plate may be configured such that the number of holes increases as a distance from the cooling air inlet increases.

The perforated plate may be configured such that the holes are arranged in a larger size as a distance from the cooling-air inlet increases.

The guide baffle may include a guide plate positioned radially inside the cooling air inlet and configured to guide the cooling air toward a perforated plate, and the perforated plate positioned relatively far from the cooling air inlet and having a plurality of holes through which the cooling air passes.

The turbine vane carrier may be manufactured separately into an upper half portion and a lower half portion, the upper half portion and the lower half portion may be coupled to each other by a pair of radial flange portions provided on the upper half portion and a pair of radial flange portions provided on the lower half portion, and the turbine vane carrier may be mounted on an inner circumferential portion of the turbine casing by the pair of radial flange portions.

The turbine vane carrier may further include a protruding portion on an upper surface of the upper half portion and a lower surface of the lower half portion, the protruding portions being configured to reduce uneven thermal expansion.

The guide baffle may be configured to cover outer surfaces of the protruding portion, and a part of the guide baffle located adjacent to the cooling air inlet in a circumferential direction among both sides of the protruding portion may have an inclined surface to smoothly guide the cooling air, and an opposite part in close contact with a side surface of the protruding portion may be formed in a stepped shape.

The turbine vane carrier may further include a pair of axial flange portions extending outwardly on both axial sides of the outer circumferential surface of the turbine vane carrier, and the guide baffle may be fastened to the pair of axial flange portions by a plurality of fastening members.

The pair of axial flange portions may be formed such that a radial length of a second axial flange portion of the pair of axial flange portions is greater than a radial length of a first axial flange portion of the pair of axial flange portions, a first side edge portion of the guide baffle may be fastened to an outer circumferential surface of the first axial flange portion by a plurality of fastening members, and a second side edge portion of the guide baffle may be fastened to a coupling member by the plurality of fastening members, the coupling member being coupled to an inner side surface of the second axial flange portion.

According to one or more exemplary embodiments, by mounting the guide baffle on the turbine vane carrier, cooling air supplied through the turbine cooling pipe is prevented from directly colliding with the turbine vane carrier, and the flow of the cooling air may spread well, so that the surface heat transfer of the turbine vane carrier may be improved.

Accordingly, the risk of wear may be reduced by reducing the uneven thermal expansion of the turbine vane carrier during gas turbine operation, and the aerodynamic performance may be improved by reducing the tip clearance of the turbine blades.

### BRIEF DESCRIPTION OF THE DRAWINGS

The above and other aspects will be more clearly understood from the following description of the exemplary embodiments with reference to the accompanying drawings, in which:

FIG. 1 is a partially cut-away perspective view illustrating a gas turbine according to an exemplary embodiment;

FIG. 2 is a cross-sectional view illustrating a schematic structure of the gas turbine according to an exemplary embodiment;

FIG. 3 is a cross-sectional view illustrating a state in which a cooling air pipe is connected from a compressor to a turbine in the gas turbine according to an exemplary embodiment;

FIG. 4 is a cross-sectional view illustrating a state in which cooling air unevenly flows to a turbine vane carrier of a gas turbine according to a related art;

FIG. 5 is a partial cross-sectional view illustrating a coupling structure of a turbine vane carrier in the gas turbine according to an exemplary embodiment;

FIG. 6 is a cross-sectional view illustrating the coupling structure of the turbine vane carrier taken along line A-A in FIG. 5;

FIG. 7 is a perspective view illustrating a structure in which a perforated plate is coupled to the turbine vane carrier according to a first exemplary embodiment;

FIG. 8 is a perspective view illustrating a structure in which the perforated plate and a guide plate are coupled to the turbine vane carrier according to a second exemplary embodiment;

FIG. 9 is a cross-sectional view illustrating a structure in which a guide baffle is coupled to the turbine vane carrier; and

FIG. 10 is an enlarged view illustrating a region B in FIG. 9.

### DETAILED DESCRIPTION

Various modifications and different embodiments will be described below in detail with reference to the accompanying drawings so that those skilled in the art can easily carry out the present disclosure. It should be understood, however, that the various embodiments are not for limiting the scope of the disclosure to the specific embodiments, but they should be interpreted to include all modifications, equivalents and alternatives of the embodiments included within the spirit and scope disclosed herein.

The terminology used herein is for the purpose of describing specific embodiments only and is not intended to limit the scope of the present disclosure. Singular expressions include plural expressions unless the context clearly indicates otherwise. In the present disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof.

Hereinafter, exemplary embodiments will be described in detail with reference to the accompanying drawings. Reference now should be made to the drawings, in which like reference numerals refer to like parts throughout various drawings and exemplary embodiments. Further, detailed descriptions related to well-known functions or configurations which may obscure the gist of the present disclosure may be omitted. For the same reason, some components may be exaggerated, omitted, or schematically illustrated in the accompanying drawings.

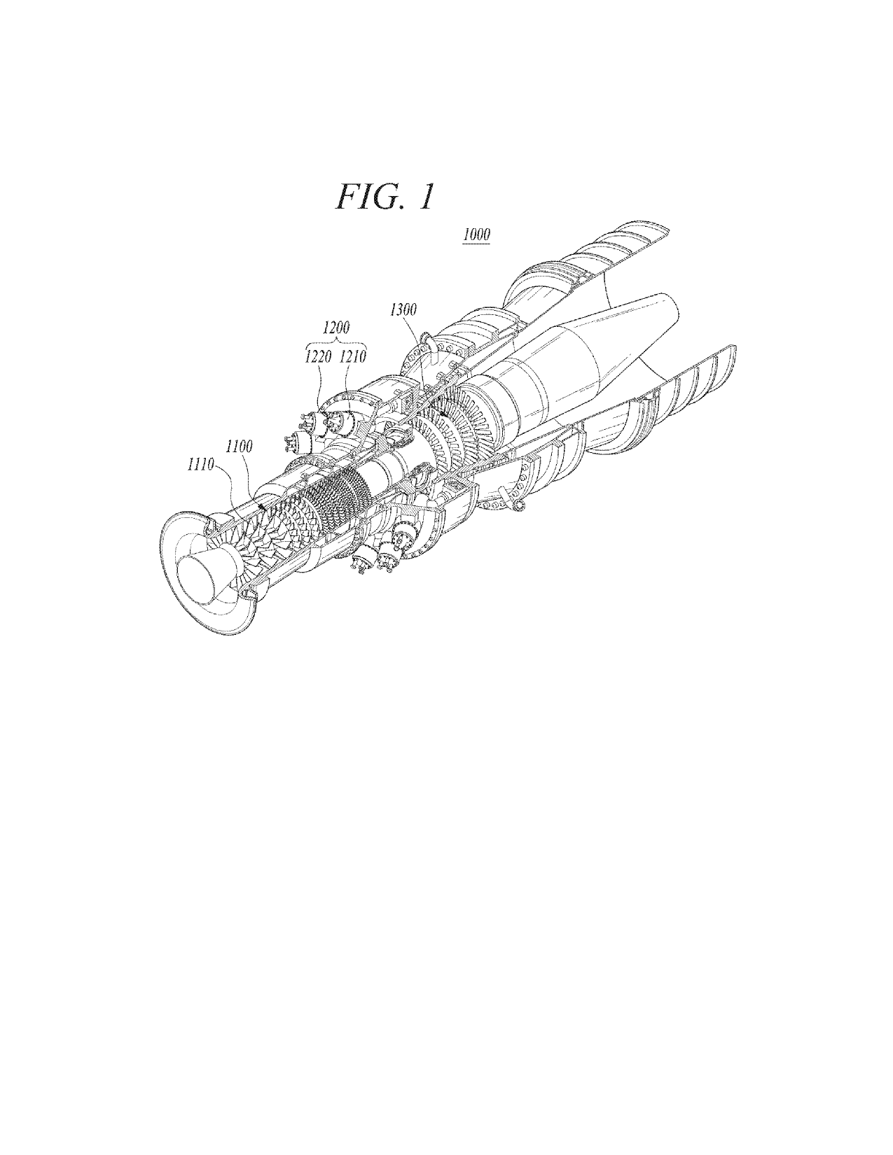

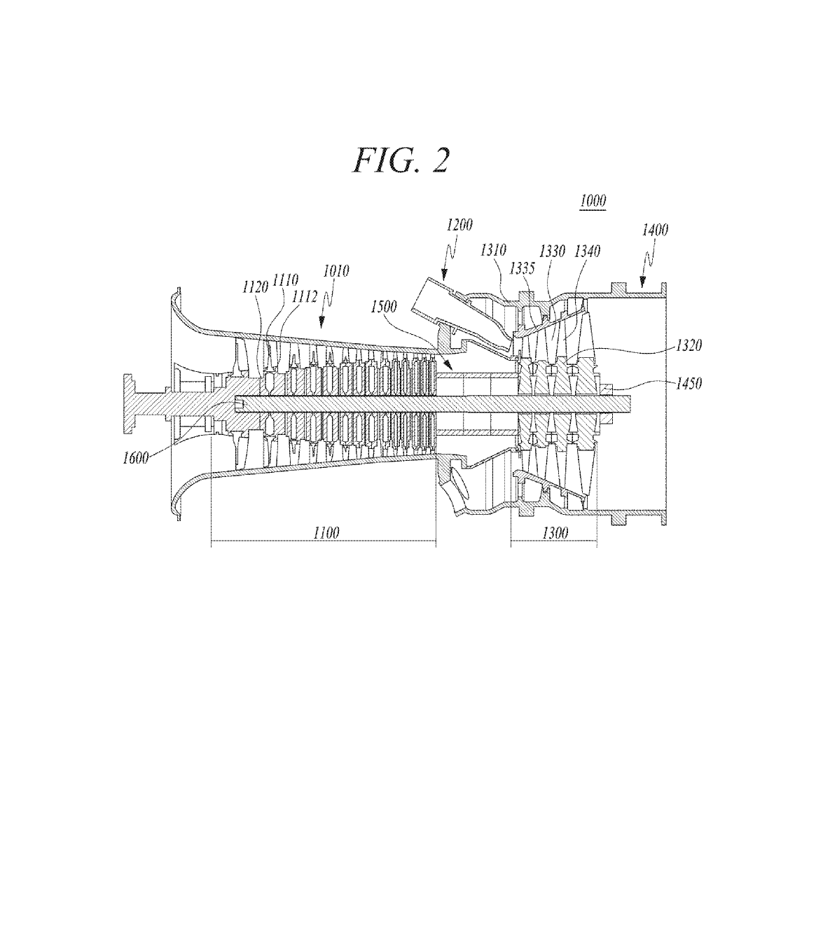

FIG. 1 is a partially cut-away perspective view illustrating a gas turbine according to an exemplary embodiment, and FIG. 2 is a cross-sectional view illustrating a schematic structure of the gas turbine according to an exemplary embodiment.

Referring to FIG. 1, a gas turbine 1000 includes a compressor 1100, a combustor 1200, and a turbine 1300. The compressor 1100 including a plurality of blades 1110 disposed radially rotates the blades 1110, and air is compressed by rotation of the blades 1110 and flows. A size and mounting angle of each of the blades 1110 may vary depending on a mounting position thereof. The compressor 1100 may be directly or indirectly connected to the turbine 1300, and may receive a portion of power generated by the turbine 1300 and rotate the blades 1110.

Air compressed by the compressor 1100 flows to the combustor 1200. The combustor 1200 includes a plurality of combustion chambers 1210 and a plurality of fuel nozzle modules 1220 disposed annularly.

Referring to FIG. 2, the gas turbine 1000 includes a housing 1010, and a diffuser 1400 disposed behind the housing 1010 to discharge a combustion gas passing through the turbine 1300. A turbine casing 1310 connected to the diffuser 1400 is provided on an outer periphery of the turbine 1300, and a turbine vane carrier 1335 is coupled to an inner side of the turbine casing 1310. The combustor 1200 is disposed in front of the diffuser 1400 to combust the compressed air supplied thereto.

Based on a flow direction of air, the compressor 1100 is positioned on an upstream side, and the turbine 1300 is positioned on a downstream side. A torque tube 1500 serving as a torque transmission member that transmits a rotational torque generated from the turbine 1300 to the compressor 1100 is disposed between the compressor 1100 and the turbine 1300.

The compressor 1100 includes a plurality of compressor rotor disks 1120 (e.g., 14 compressor rotor disks) each of which is fastened by a tie rod 1600 to prevent axial separation in an axial direction of the tie rod 1600.

For example, each of the compressor rotor disks 1120 is axially aligned in a state in which the tie rod 1600 forming a rotary shaft passes approximately through a central portion of each of the compressor rotor disks 1120. Here, adjacent compressor rotor disks 1120 are disposed such that facing surfaces thereof are in tight contact with each other by being pressed by the tie rod 1600. The adjacent compressor rotor disks 1120 cannot rotate because of this arrangement.

Each of the compressor rotor disks 1120 has a plurality of compressor blades 1110 radially coupled to an outer circumferential surface thereof. Each of the blades 1110 has a dovetail portion 1112 fastened to each of the compressor rotor disks 1120.

A plurality of vanes are fixedly disposed in the housing 1010 between each of the compressor rotor disks 1120. While the compressor rotor disks 1120 rotate along with a rotation of the tie rod 1600, the vanes fixed to the housing 1010 do not rotate. The vanes guide the flow of the compressed air moved from front-stage blades 1110 to rear-stage blades 1110.

The dovetail portion 1112 may be fastened by a tangential type or an axial type, which may be selected according to a structure of a gas turbine. The dovetail portion 1112 may have a dovetail shape or a fir-tree shape. In some cases, the blades 1110 may be fastened to the compressor rotor disks 1120 by using other types of fastening member such as a key or a bolt.

The tie rod 1600 is disposed to pass through central portions of the plurality of compressor rotor disks 1120 and a plurality of turbine rotor disks 1320. The tie rod 1600 may be a single tie rod or a plurality of tie rods. One end of the tie rod 1600 is fastened to a most upstream compressor rotor disk 1120, and the other end thereof is fastened by a fixing nut 1450.

It is understood that the type of the tie rod 1600 may not be limited to the example illustrated in FIG. 2, and may be changed or vary according to one or more other exemplary embodiments. For example, a single tie rod may be disposed to pass through the central portions of the rotor disks, a plurality of tie rods may be arranged circumferentially, or a combination thereof may be used.

Also, in order to increase the pressure of fluid and then adjust an actual inflow angle of the fluid entering into an inlet of the combustor, a deswirler serving as a guide vane may be installed at the rear stage of the diffuser of the compressor 1100 so that the actual inflow angle matches a designed inflow angle.

The combustor 1200 mixes fuel with the introduced compressed air, combusts a fuel-air mixture to produce a high temperature and high pressure combustion gas with a high energy, and increases the temperature of the combustion gas to a temperature at which the combustor and the turbine components are able to be resistant to heat through an isobaric combustion process.

A plurality of combustors constituting the combustor 1200 may be arranged in the housing in a form of a cell. Each of the combustors may include a burner having a fuel injection nozzle and so on, a combustor liner forming a combustion chamber, and a transition piece serving as a connection part between the combustor and the turbine.

The combustor liner provides a combustion space in which fuel injected by the fuel injection nozzle is mixed with the compressed air supplied from the compressor and combusted. The combustor liner may include a flame container providing the combustion space in which fuel mixed with air is combusted, and a flow sleeve forming an annular space while surrounding the flame container. The fuel injection nozzle is coupled to a front end of the combustor liner, and an ignition plug is coupled to a side wall of the combustor liner.

The transition piece is connected to a rear end of the combustor liner to transfer the combustion gas toward the turbine. An outer wall of the transition piece is cooled by compressed air supplied from the compressor to prevent the transition piece from being damaged due to the high temperature of the combustion gas.

To this end, the transition piece has cooling holes through which the compressed air is injected, and the compressed air cools the inside of the transition piece and then flows toward the combustor liner.

The compressed air that has cooled the transition piece may flow into an annular space of the combustor liner, and may be supplied as a cooling air through the cooling holes formed in the flow sleeve from the outside of the flow sleeve to an outer wall of the combustor liner.

The high temperature and high pressure combustion gas ejected from the combustor 1200 is supplied to the turbine 1300. The supplied high temperature and high pressure combustion gas expands and applies impingement or reaction force to the turbine blades to generate rotational torque. A portion of the acquired rotational torque is transmitted via the torque tube to the compressor, and the remaining portion that is the excessive torque is used to drive a generator and so on.

The turbine 1300 basically has a structure similar to the compressor 1100. That is, the turbine 1300 includes the plurality of turbine rotor disks 1320 similar to the compressor rotor disks of the compressor. The plurality of turbine rotor disks 1320 includes a plurality of turbine blades 1340 arranged radially. The turbine blades 1340 may be coupled to the turbine rotor disks 1320 in a dovetail coupling manner or the like. In addition, a plurality of turbine vanes 1330 fixed to the turbine casing 1310 are provided between the turbine blades 1340 of the turbine rotor disks 1320 to guide a flow direction of the combustion gas passing through the turbine blades 1340.

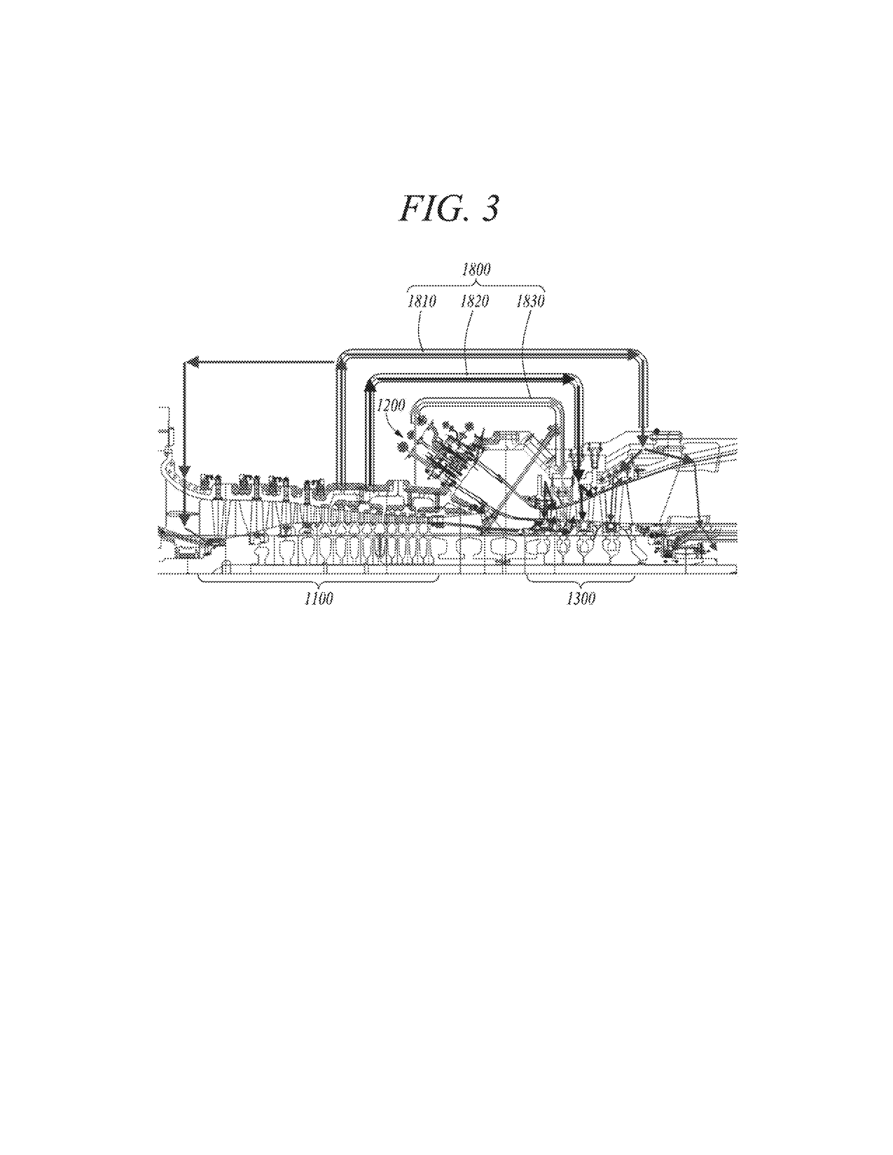

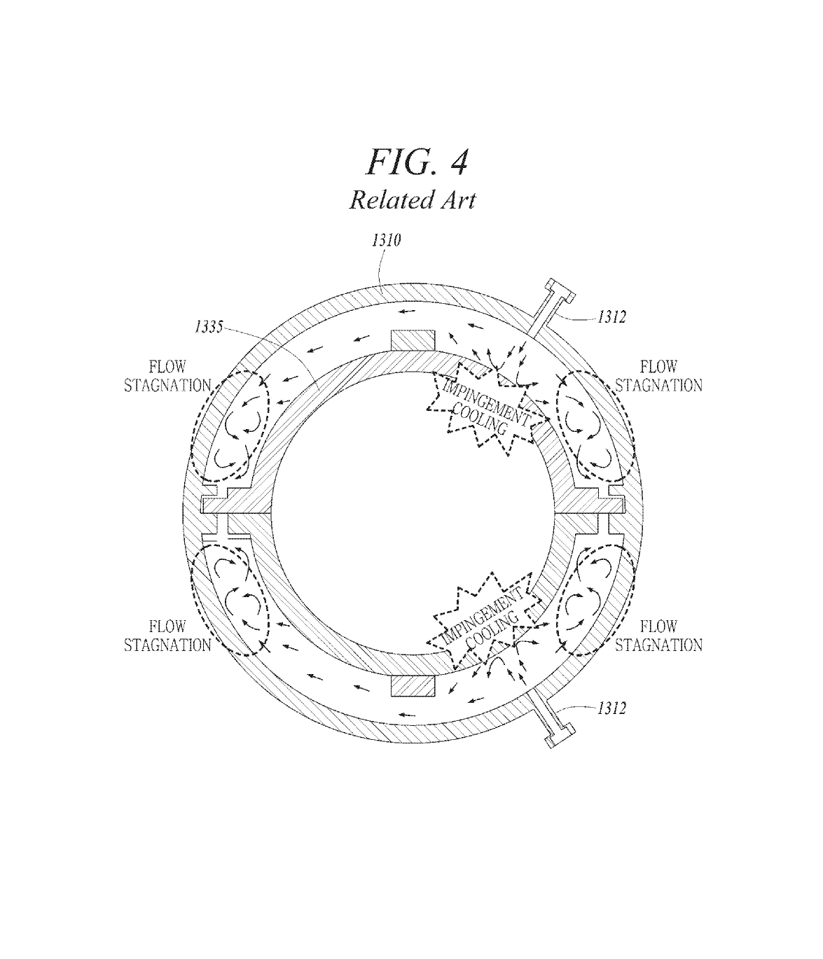

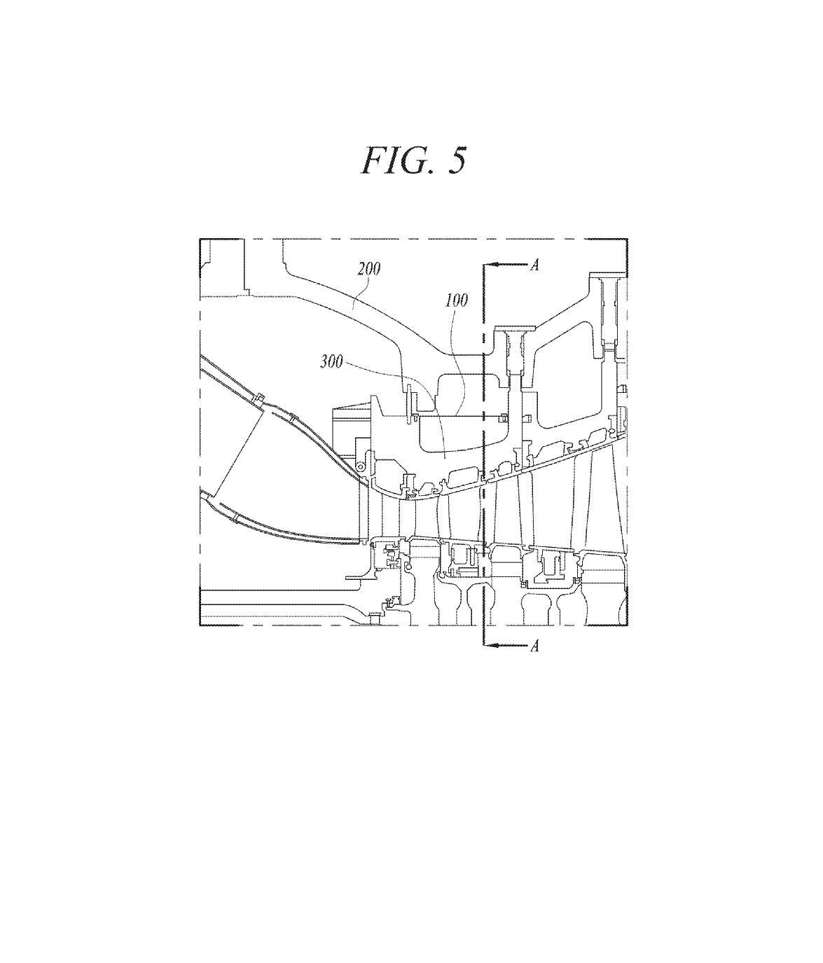

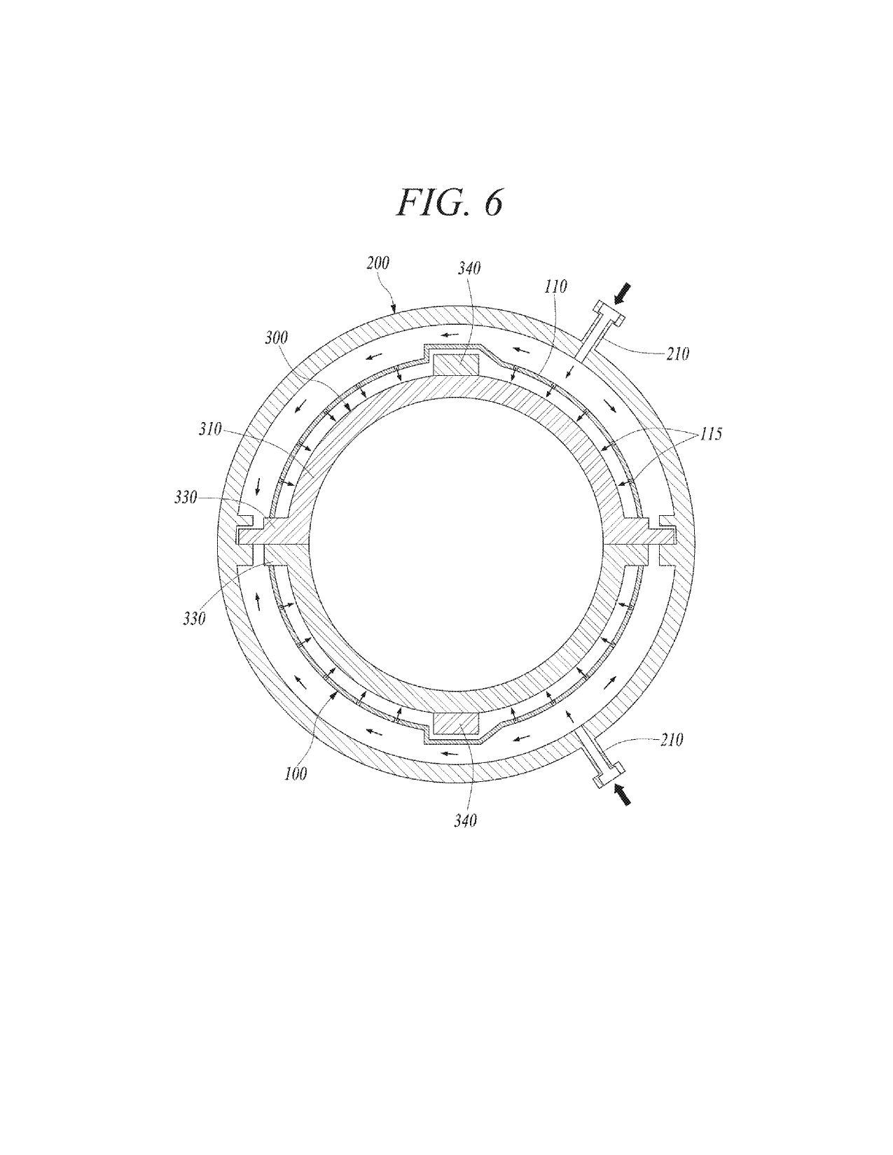

FIG. 3 is a cross-sectional view illustrating a state in which a cooling air pipe is connected from the compressor to the turbine in the gas turbine according to an exemplary embodiment, FIG. 4 is a cross-sectional view illustrating a state in which cooling air unevenly flows to a turbine vane carrier of a gas turbine according to a related art, FIG. 5 is a partial cross-sectional view illustrating a coupling structure of a turbine vane carrier in the gas turbine according to an exemplary embodiment, and FIG. 6 is a cross-sectional view illustrating the coupling structure of the turbine vane carrier taken along line A-A in FIG. 5.

Referring to FIG. 3, in the gas turbine 1000, cooling may be performed by supplying additional compressed air from the compressor 1100 to cool the turbine 1300. To this end, a plurality of cooling air pipes 1800 may be provided to supply compressed air from the compressor 1100 to the turbine 1300. The plurality of cooling air pipes 1800 may include a first cooling air pipe 1810 that supplies cooling air from a front end of the compressor 1100 to a third fourth stages of the turbine 1300, a second cooling air pipe 1820 that supplies cooling air from a relatively middle end of the compressor 1100 to a second stage of the turbine 1300, and a third cooling air pipe 1830 that supplies cooling air from a relatively rear end of the compressor 1100 to a first stage of the turbine 1300.

The first stage of the turbine 1300 has a relatively high temperature and may be cooled using air from the rear end of the compressor 1100, and the third and fourth stages of the turbine 1300 have relatively low temperatures and may be cooled using air from the front end of the compressor 1100.

The reason for using high pressure air at the rear end of the compressor 1100 to cool the first stage of the high temperature turbine 1300 is as follows. In the multi-stage compressor 1100, the compressed air at the rear end of the compressor 1100 has a relatively high pressure and temperature. On the other hand, the combustion gas flowing inside the turbine 1300 has a very high pressure and temperature at the first stage of the turbine 1300, and the pressure and temperature of the combustion gas gradually decrease as it moves toward the fourth stage of the turbine 1300. To supply cooling air to the first stage of the turbine 1300, the pressure of the compressed air must be higher than the pressure of the combustion gas inside the first stage of the turbine 1300. Accordingly, the first stage of the turbine 1300 is cooled using air at the rear end of the compressor 1100, and the air is compressed to a pressure higher than the pressure of the combustion gas inside the first stage of the turbine 1300. The temperature of air at the rear end of the compressor 1100 is higher than the temperature of air at the front end of the compressor 1100, but the temperature of the first stage of the turbine 1300 is much higher than the temperature of the air at the rear end of the compressor 1100, so the first stage of the turbine 1300, which is at a high temperature, may be cooled sufficiently using the high pressure air at the rear end of the compressor 1100.

The reason for using low pressure air at the front end of the compressor 1100 to cool the third and fourth stages of the turbine 1300 having the relatively low temperature is as follows. Compressed air at the front end of the compressor 1100 has the relatively low pressure and temperature. Because the pressure and temperature of the combustion gas at the third and fourth stages of the turbine 1300 are relatively lower than those at the first stage of the turbine 1300, the pressure of the compressed air at the front end of the compressor 1100 is higher than the pressure of the combustion gas at the third and fourth stages of the turbine 1300. Therefore, the third and fourth stages of the turbine 1300 may be cooled by supplying the compressed air at the front end of the compressor 1100 to the third and fourth stages of the turbine 1300. As long as the pressure of the compressed air supplied from the compressor 1100 is higher than the pressure inside the turbine 1300, the compressed air may be supplied to the turbine 1300 to cool the inside of the turbine 1300. In this case, the lower the temperature of the compressed air, the more advantageous the cooling effect for the turbine 1300 is.

Therefore, the durability of the components may be maintained by appropriately cooling the components of the turbine 1300 having high temperature using air compressed by the compressor 1100. At this time, cooling air flows through a chamber between the turbine casing 1310 and the turbine vane carrier 1335 that supports the turbine vanes 1330, and the cooling air flows toward the turbine vanes 1330.

Even if each stage of the turbine 1300 is cooled using air at the front, middle, and rear ends of the compressor 1100 as described above, uneven flow may occur inside the turbine casing 1310 as a circumferential distance from a connection portion of the cooling air pipe increases.

Referring to FIG. 4, in a related art, a cooling air pipe supplying cooling air to the turbine 1300 may be connected to a cooling air inlet 1312 provided at upper and lower portions of the turbine casing 1310. The turbine vane carrier 1335 having an outer diameter smaller than an inner diameter of the turbine casing 1310 is mounted inside the turbine casing 1310.

Therefore, cooling air supplied from the upper and lower cooling air inlets 1312 collides with the turbine vane carrier 1335 positioned radially inside the upper and lower cooling air inlets 1312, and flows in both circumferential directions, thereby cooling the turbine vane carrier 1335.

However, a portion of the turbine vane carrier 1335 positioned directly inside the cooling air inlet 1312 is intensively cooled by impingement cooling, but a portion of the turbine vane carrier 1335 positioned relatively far from the cooling air inlet 1312 may cause uneven flow or flow stagnation, which may cause uneven thermal expansion depending on the position of the turbine vane carrier 1335.

This uneven thermal expansion may increase a risk of wear during the gas turbine operation and reduce a durability of the gas turbine.

Referring to FIG. 5 and FIG. 6, the turbine 1300 includes a turbine vane carrier 300 having an inner circumferential surface to which the plurality of turbine vanes 1330 are coupled, a turbine casing 200 having an inner portion on which the turbine vane carrier 300 is mounted, the turbine casing 200 being provided with a cooling air inlet 210 configured to supply cooling air toward the turbine vane carrier 300, and a guide baffle 100 mounted on an outer circumference of the turbine vane carrier 300 and configured to guide cooling air supplied through the cooling air inlet 210 to an outer circumferential surface of the turbine vane carrier 300.

The turbine casing 200 forms an outer periphery of the turbine 1300 and may be coupled such that the turbine casing 200 is connected to the diffuser 1400.

The turbine vane carrier 300 is coupled to an inner side of the turbine casing 200, and the plurality of turbine vanes 1330 may be mounted on the inner circumferential surface of the turbine vane carrier 300.

A flow path chamber through which cooling air flows may be formed between the inner circumferential surface of the turbine casing 200 and the outer circumferential surface of the turbine vane carrier 300. The cooling air inlet 210 may be disposed on the upper and lower portions of the turbine casing 200. A cooling air pipe that supplies cooling air compressed by the compressor 1100 may be connected to the cooling air inlet 210.

Two to four cooling air inlets 210 may be arranged on the outer circumferential surface of the turbine casing 200. In addition, when two cooling air inlets 210 are provided, the two cooling air inlets 210 may be disposed on an upper right side and a lower right side of the turbine casing 200 according to a mounting environment and an arrangement structure of the gas turbine 1000.

The guide baffle 100 is coupled to an outer side of the turbine vane carrier 300 and may be disposed such that the guide baffle 100 partitions a flow chamber space between the turbine casing 200 and the turbine vane carrier 300. The guide baffle 100 may be configured such that cooling air supplied through the cooling air inlet 210 is guided circumferentially along the outer circumferential surface of the turbine vane carrier 300.

Referring to FIG. 6, when the two cooling air inlets 210 are asymmetrically disposed on the upper right side and the lower right side of the turbine casing 200, the guide baffle 100 is required to address the uneven cooling air flow situation.

The guide baffle 100 may include a perforated plate 110 having a plurality of holes 115 through which cooling air passes.

The turbine vane carrier 300 is separately manufactured into an upper half portion of the turbine vane carrier 300 and a lower half portion of the turbine vane carrier 300, the upper and lower half portions of the turbine carrier 300 are coupled to each other by a pair of radial flange portions 330, and the upper and lower half portions of the turbine carrier 300 can be mounted on the inner circumferential portion of the turbine casing 200 by the pair of radial flange portions 330.

The turbine vane carrier 300 has a cylindrical body portion 310 that is manufactured separately into an upper and lower half portions, and the upper and lower half portions of the body portion 310 include the pair of radial flange portions 330, so that the upper and lower half portions of the body portion 310 can be fastened and coupled to each other by a plurality of bolts and nuts. The pair of radial flange portions 330 may extend radially from both ends of the body portion 310 by a predetermined length, and may extend continuously in an axial direction.

The pair of radial flange portions 330 coupled to each other may be mounted and fixed to a pair of mounting ribs provided on the inner circumferential surface of the turbine casing 200.

The turbine vane carrier 300 may further include a protrusion portion 340 protruding from an upper surface of the upper half portion and a lower surface of the lower half portion to reduce uneven thermal expansion.

Each protrusion portion 340 may be integrally formed at an upper and lower ends of the outer circumferential surface of the turbine vane carrier 300 such that a thickness of the outer circumferential surface of the turbine vane carrier 300 increases and the protrusion portion 340 extends in the axial direction. The pair of radial flange portions 330 are integrally formed at both ends of the outer circumferential surface of the turbine vane carrier 300. Therefore, by forming the pair of protrusion portions 340 on the upper and lower ends of the outer circumferential surface of the turbine vane carrier 300, deformation due to uneven thermal expansion of the body portion 310 of the turbine vane carrier 300 may be reduced.

The guide baffle 100 may be formed as a pair of curved bands having a semi-circular cross-section. The pair of guide baffles 100 may be positioned from the outer circumferential surface of the turbine vane carrier 300 to the pair of radial flange portions 330. In addition, the pair of guide baffles 100 may be formed to cover outer surfaces of the protrusion portions 340 protruding from the outer circumferential surface of the turbine vane carrier 300. At this time, each guide baffle 100 may have a portion of the guide baffle 100 positioned adjacent to the cooling air inlet 210 among both side portions of the protrusion portion 340 in the circumferential direction such that the portion thereof has an inclined surface to smoothly guide cooling air, and an opposite portion of the guide baffle 100 is formed in a stepped shape that is in close contact with a side surface of the protrusion portion 340.

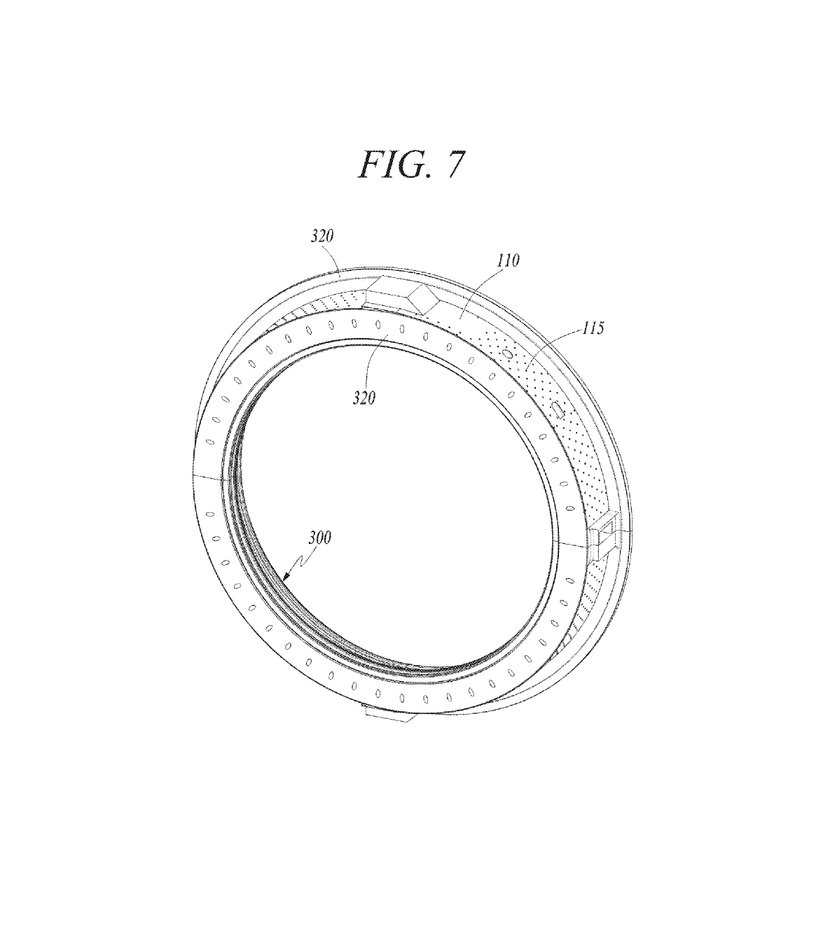

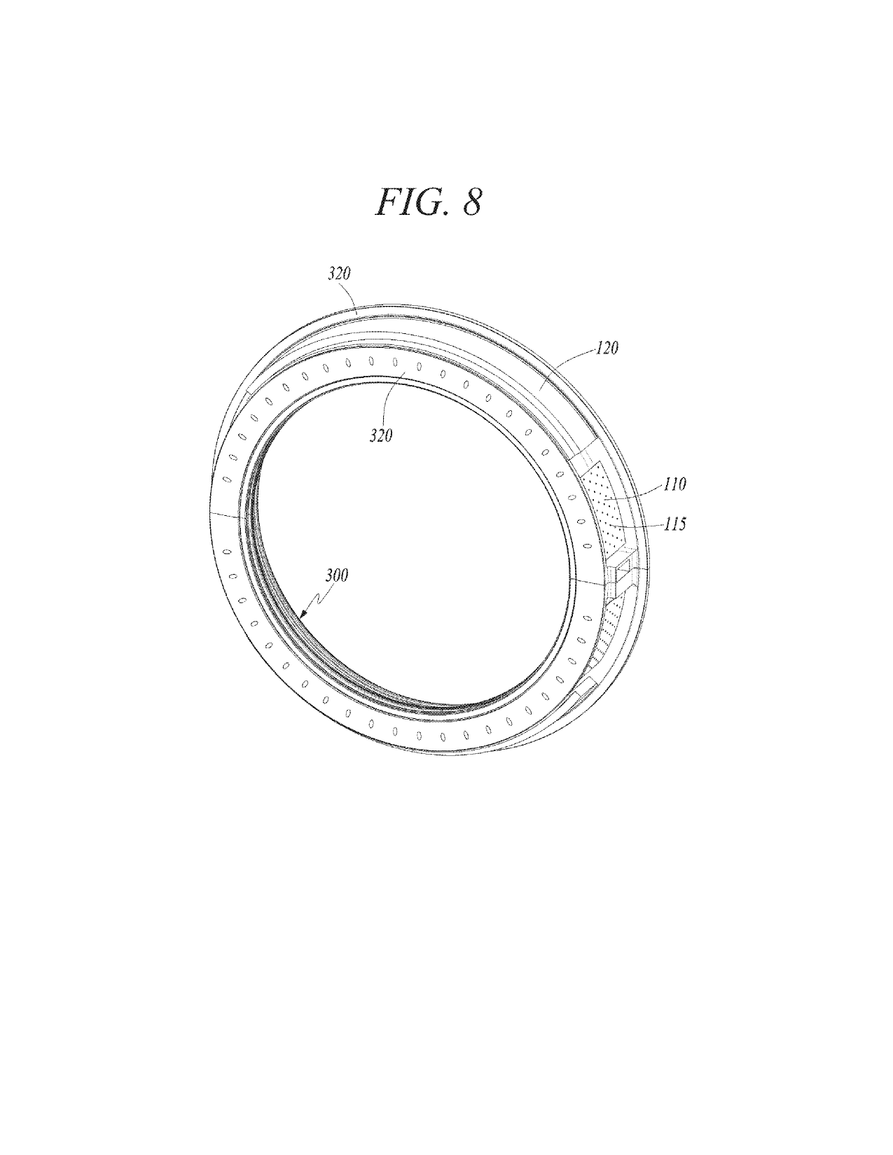

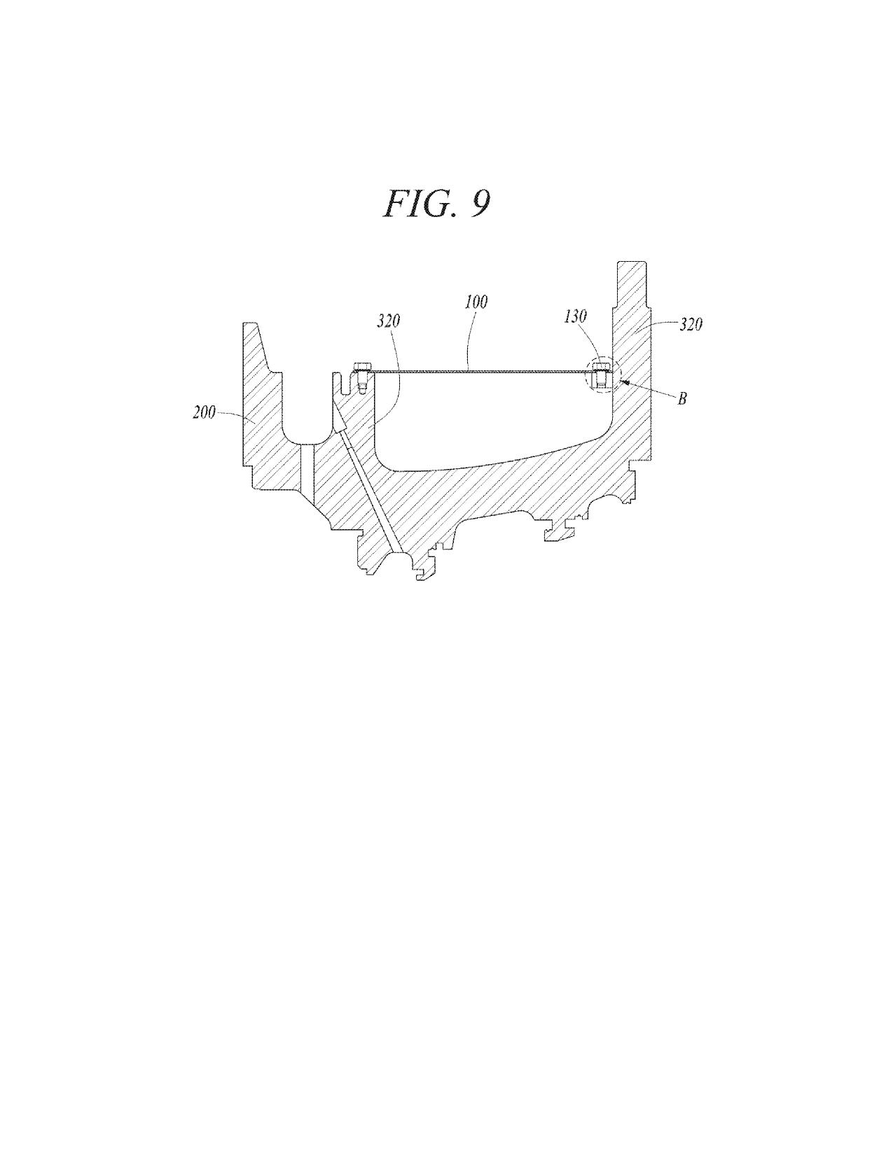

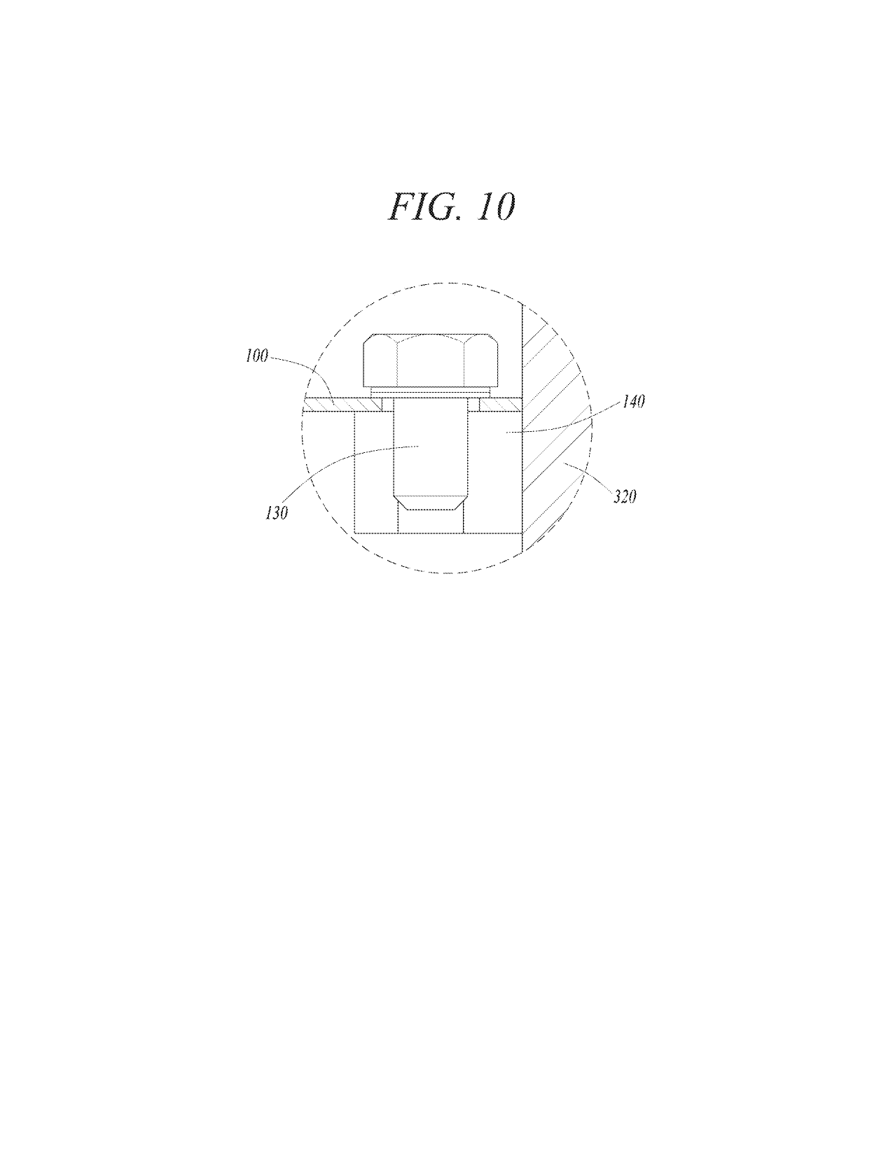

FIG. 7 is a perspective view illustrating a structure in which the perforated plate is coupled to the turbine vane carrier according to a first exemplary embodiment, and FIG. 8 is a perspective view illustrating a structure in which the perforated plate and a guide plate are coupled to the turbine vane carrier according to a second exemplary embodiment. FIG. 9 is a cross-sectional view illustrating a structure in which the guide baffle is coupled to the turbine vane carrier, and FIG. 10 is an enlarged view illustrating a region B in FIG. 9.

Referring to FIG. 7, the turbine vane carrier 300 may be separately manufactured into the upper half portion and the lower half portion, and the upper and lower half portions of the turbine vane carrier 300 may be coupled to each other. The turbine vane carrier 300 may further include a pair of axial flange portions 320 extending outward from both axial sides of the outer circumferential surface of the turbine vane carrier 300.

The pair of axial flange portions 320 may extend radially outward by a predetermined length from edge portions of both axial ends (in a width direction) of the body portion 310 of the turbine vane carrier 300, and may be formed continuously in a circumferential direction. A plurality of fastening holes may be formed in the pair of axial flange portions 320 so as to be coupled to each other.

The perforated plate 110 may be mounted at a predetermined distance from the outer circumferential surface of the body portion 310 of the turbine vane carrier 300. The perforated plate 110 may be mounted by forming a single member for each of the upper and lower half portions of the body portion 310, or may be mounted by forming a plurality of members.

The perforated plate 110 may be formed such that a greater number of holes 115 are arranged in an increasingly larger arrangement as the distance from the cooling air inlet 210 increases.

In the perforated plate 110 shown in FIG. 7, the holes 115 through which cooling air flows are not formed in a region adjacent to the inner side of the cooling air inlet 210 and a region of the protrusion portion 340. This is because it is preferable that a region of the turbine vane carrier 300 adjacent to the inner side of the cooling air inlet 210 is not excessively cooled due to direct impingement cooling.

In FIG. 7, the plurality of holes 115 are spaced at regular intervals and formed with a uniform size in other regions of the perforated plate 110, but may be arranged to gradually increase density per unit area of the perforated plate 110 as the plurality of holes 115 are positioned further away from the cooling air inlet 210.

The perforated plate 110 may be arranged such that the sizes of the holes 115 gradually increase as the holes 115 are positioned further away from the cooling air inlet 210.

In FIG. 7, the holes 115 having the same size are formed in the perforated plate 110, but the holes 115 may be formed to gradually increase in size as the holes 115 are positioned further away from the cooling air inlet 210.

In addition, the plurality of holes 115 in the perforated plate 110 may be arranged such that the larger holes 115 are gradually arranged as the holes 115 are positioned further away from the cooling air inlet 210, and denser arrangements may be made as the holes 115 are positioned further away from the cooling air inlet 210.

Referring to FIG. 8, the guide baffle 100 may include a guide plate 120 disposed radially inward of the cooling air inlet 210 to guide cooling air toward the perforated plate 110, and may include the perforated plate 110 positioned relatively far away from the cooling air inlet 210 and having the plurality of holes 115 through which cooling air passes.

The holes 115 are not formed in the guide plate 120, and the guide plate 120 may be disposed to cover a region adjacent to the cooling air inlet 210 and the protrusion portion 340. The guide plate 120 may guide cooling air supplied from the cooling air inlet 210 toward the perforated plate 110 through a path on an outer circumferential surface of the guide plate 120.

The perforated plate 110 may be disposed in a region of the outer circumferential surface of the body portion 310 of the turbine vane carrier 300 where the guide plate 120 is not positioned. The perforated plate 110 through which the plurality of holes 115 pass may be disposed at a position radially lower than the guide plate 120.

Cooling air supplied from the cooling air inlet 210 may flow along an outer circumferential portion of the guide plate 120 and may be intensively supplied to the outer circumferential surface of the turbine vane carrier 300 positioned further away from the cooling air inlet 210 through the holes 115 of the perforated plate 110. Accordingly, the outer circumferential surface of the turbine vane carrier 300 may be evenly cooled.

Referring to FIG. 7 to FIG. 9, the turbine vane carrier 300 may further include the pair of axial flange portions 320 extending outwardly from both axial sides of the outer circumferential surface of the turbine vane carrier 300.

As illustrated in FIG. 5, the pair of axial flange portions 320 may extend radially outward in both axial directions (width direction) of the outer circumferential surface of the turbine vane carrier 300, and may be coupled to the inner circumferential surface of the turbine casing 200 by a fixing member.

The guide baffle 100 may be fastened and coupled to the pair of axial flange portions 320 by a plurality of fastening members 130.

To this end, as shown in FIG. 7, a plurality of fastening holes through which the plurality of fastening members 130 pass may be formed at both edges of the guide baffle 100 in the width direction.

Referring to FIG. 5 and FIG. 9, the pair of axial flange portions 320 may be formed such that a radial length of a second axial flange portion 320 is greater than a radial length of a first axial flange portion 320.

The plurality of turbine vanes 1330 and the plurality of turbine blades 1340 arranged inside the turbine vane carrier 300 may have different radial lengths according to positions of the plurality of stages. Therefore, the pair of axial flange portions 320 integrally provided on the outer circumferential portion of the turbine vane carrier 300 may have different radial extension lengths according to a shape in which the radius of the inner circumferential surface of the turbine vane carrier 300 varies.

In detail, the radius of the turbine 1300 generally increases from the first stage of the turbine 1300 to the fourth stage of the turbine 1300. Therefore, as shown in FIG. 5 and FIG. 9, the radial extension length of the axial flange portion 320 at a right side may be formed to be greater than the radial extension length of the axial flange portion 320 at a left side.

Referring to FIG. 9, a first edge portion of the guide baffle 100 may be fastened to the outer circumferential surface of the axial flange portion 320 at a first side by the plurality of fastening members 130, and a second edge portion of the guide baffle 100 may be fastened to a coupling member 140 by the plurality of fastening members 130, and the coupling member 140 is coupled to an inner side surface of the axial flange portion 320 at a second side.

In FIG. 9, a fastening hole may be formed on the left side of the axial flange portion 320 from the outer circumferential surface toward the radial inner side. Accordingly, by fastening the fastening member 130 to the fastening hole through a penetration hole formed in a left edge portion of the guide baffle 100, a left portion of the guide baffle 100 may be fixed to the outer circumferential surface of the axial flange portion 320.

Referring to FIG. 10, the coupling member 140 may be welded to the inner circumferential surface of the axial flange portion 320 at the right side. The fastening hole may be formed in the coupling member 140 in an up and down direction (radial direction). Accordingly, by fastening the fastening member 130 formed of a bolt or the like to the fastening hole through the penetration hole formed in a right edge portion of the guide baffle 100, a right portion of the guide baffle 100 may be fixed to an outer circumferential surface (upper surface) of the coupling member 140. At this time, a washer may be inserted between a bolt head portion of the fastening member 130 and the guide baffle 100 while the fastening member 130 is fastened to the guide baffle 100.

According to the turbine including the guide baffle mounted on the turbine vane carrier , as the guide baffle is mounted on the turbine vane carrier, cooling air supplied through a turbine cooling pipe may be prevented from directly colliding with the turbine vane carrier, and the flow of the cooling air may be spread well, thereby improving surface heat transfer of the turbine vane carrier.

Accordingly, uneven thermal expansion of the turbine vane carrier during the gas turbine operation may be solved, the risk of wear may be reduced, and aerodynamic performance may be improved by reducing a tip clearance of the turbine blades.

While one or more exemplary embodiments have been described with reference to the accompanying drawings, it will be apparent to those skilled in the art that various variations and modifications in form and details may be made by adding, changing, or removing components without departing from the spirit and scope of the present disclosure as defined in the appended claims, and these variations and modifications fall within the spirit and scope of the present disclosure as defined in the appended claims. Accordingly, the description of exemplary embodiments should be construed in a descriptive sense only and not to limit the scope of the claims, and many alternatives, modifications, and variations will be apparent to those skilled in the art.

What is claimed is:

1. A turbine comprising:
a turbine vane carrier having an inner circumferential surface to which a plurality of turbine vanes are coupled;
a turbine casing having an inner portion on which the turbine vane carrier is mounted, the turbine casing being provided with a cooling air inlet configured to supply cooling air towards the turbine vane carrier; and
a guide baffle mounted on an outer circumferential portion of the turbine vane carrier and configured to guide the cooling air supplied through the cooling air inlet to an outer circumferential surface of the turbine vane carrier.

2. The turbine of claim 1, wherein the guide baffle comprises a perforated plate having a plurality of holes through which the cooling air passes.

3. The turbine of claim 2, wherein the perforated plate is configured such that the number of holes increases as a distance from the cooling air inlet increases.

4. The turbine of claim 2, wherein the perforated plate is configured such that the holes are arranged in a larger size as a distance from the cooling air inlet increases.

5. The turbine of claim 1, wherein the guide baffle comprises:
a guide plate positioned radially inside the cooling air inlet and configured to guide the cooling air toward a perforated plate; and
the perforated plate positioned relatively far from the cooling air inlet and having a plurality of holes through which the cooling air passes.

6. The turbine of claim 1, wherein the turbine vane carrier is manufactured separately into an upper half portion and a lower half portion, the upper half portion and the lower half portion are coupled to each other by a pair of radial flange portions provided on the upper half portion and a pair of radial flange portions provided on the lower half portion, and the turbine vane carrier is mounted on an inner circumferential portion of the turbine casing by the pair of radial flange portions.

7. The turbine of claim 6, wherein the turbine vane carrier further comprises a protruding portion on an upper surface of the upper half portion and a lower surface of the lower half portion, the protruding portions being configured to reduce uneven thermal expansion.

8. The turbine of claim 7, wherein the guide baffle is configured to cover outer surfaces of the protruding portion, and a part of the guide baffle located adjacent to the cooling air inlet in a circumferential direction among both sides of the protruding portion has an inclined surface to smoothly guide the cooling air, and an opposite part in close contact with a side surface of the protruding portion is formed in a stepped shape.

9. The turbine of claim 6, wherein the turbine vane carrier further comprises a pair of axial flange portions extending outwardly on both axial sides of the outer circumferential surface of the turbine vane carrier, and the guide baffle is fastened to the pair of axial flange portions by a plurality of fastening members.

10. The turbine of claim 9, wherein the pair of axial flange portions is formed such that a radial length of a second axial flange portion of the pair of axial flange portions is greater than a radial length of a first axial flange portion of the pair of axial flange portions,
wherein a first side edge portion of the guide baffle is fastened to an outer circumferential surface of the first axial flange portion by a plurality of fastening members, and
wherein a second side edge portion of the guide baffle is fastened to a coupling member by the plurality of fastening members, the coupling member being coupled to an inner side surface of the second axial flange portion.

11. A gas turbine comprising:
a compressor configured to compress external air;
a combustor configured to mix fuel with air compressed in the compressor to combust a mixture thereof;
a turbine having a turbine casing in which a plurality of turbine blades and a plurality of turbine vanes are mounted, the plurality of turbine blades being rotated by a combustion gas discharged from the combustor;
a turbine vane carrier having an inner circumferential surface to which the plurality of turbine vanes are coupled;
the turbine casing having an inner portion on which the turbine vane carrier is mounted, the turbine casing being provided with a cooling air inlet configured to supply cooling air towards the turbine vane carrier; and
a guide baffle mounted on an outer circumferential portion of the turbine vane carrier and configured to guide the cooling air supplied through the cooling air inlet to an outer circumferential surface of the turbine vane carrier.

12. The gas turbine of claim 11, wherein the guide baffle comprises a perforated plate having a plurality of holes through which the cooling air passes.

13. The gas turbine of claim 12, wherein the perforated plate is configured such that the number of holes increases as a distance from the cooling air inlet increases.

14. The gas turbine of claim 12, wherein the perforated plate is configured such that the holes are arranged in a larger size as a distance from the cooling-air inlet increases.

15. The gas turbine of claim 11, wherein the guide baffle comprises:
a guide plate positioned radially inside the cooling air inlet and configured to guide the cooling air toward a perforated plate; and
the perforated plate positioned relatively far from the cooling air inlet and having a plurality of holes through which the cooling air passes.

16. The gas turbine of claim 11, wherein the turbine vane carrier is manufactured separately into an upper half portion and a lower half portion, the upper half portion and the lower half portion are coupled to each other by a pair of radial flange portions provided on the upper half portion and a pair of radial flange portions provided on the lower half portion, and the turbine vane carrier is mounted on an inner circumferential portion of the turbine casing by the pair of radial flange portions.

17. The gas turbine of claim 16, wherein the turbine vane carrier further comprises a protruding portion on an upper surface of the upper half portion and a lower surface of the lower half portion, the protruding portions being configured to reduce uneven thermal expansion.

18. The gas turbine of claim 17, wherein the guide baffle is configured to cover outer surfaces of the protruding portion, and a part of the guide baffle located adjacent to the cooling air inlet in a circumferential direction among both sides of the protruding portion has an inclined surface to smoothly guide the cooling air, and an opposite part in close contact with a side surface of the protruding portion is formed in a stepped shape.

19. The gas turbine of claim 16, wherein the turbine vane carrier further comprises a pair of axial flange portions extending outwardly on both axial sides of the outer circumferential surface of the turbine vane carrier, and the guide baffle is fastened to the pair of axial flange portions by a plurality of fastening members.

20. The gas turbine of claim 19, wherein the pair of axial flange portions is formed such that a radial length of a second axial flange portion of the pair of axial flange portions is greater than a radial length of a first axial flange portion of the pair of axial flange portions,
wherein a first side edge portion of the guide baffle is fastened to an outer circumferential surface of the first axial flange portion by a plurality of fastening members, and
wherein a second side edge portion of the guide baffle is fastened to a coupling member by the plurality of fastening members, the coupling member being coupled to an inner side surface of the second axial flange portion.
